(19) United States
(12) Patent Application Publication
(10) Pub. No.: US 2012/0201931 A1
(43) Pub. Date: Aug. 9, 2012

(54) Fast disintegrating coffee, tea and food powder

(76) Inventor: Darral Rodney Addison, (US)

(21) Appl. No.: 13/021,832

(22) Filed: Feb. 7, 2011

(51) Int. Cl. A23L 2/395

(52) U.S. Cl. 426/72

(57) ABSTRACT

A Super Fast Disintegration Powder that's comprised of tea, coffee and various food extracts, sugars, flavorings, colorants, and a superfast disintigrant. The powder has a particle size of 200 micrometers to 2 mm. The Super Fast Disintegration Powder is comprised of approved and generally recognized as safe sugars, flavorings, FD&C approved coloring agents, vitamins, minerals, nutraceuticals, spices, tea and coffee extracts or any combination thereof, and a Super fast disintegrant that is used as a carrier to deliver the contents. The above ingredients have been heated, sprayed, spun and dried on to a Super Fast Disintegrant for the purpose of establishing a new mode of delivery for tea, coffee and food based products.

### SUMMARY

The purpose of this patent is to introduce fast disintegrating technology in the form of a powder as a new delivery system for approved and generally recognized as safe sugars, flavorings, FD&C approved coloring agents, vitamins, minerals, nutraceuticals, spices, tea and coffee extracts or any combination thereof, and a Super fast disintegrant that is used as a carrier to deliver the contents. Depending upon each ingredients hygroscopicity, porosity, crystal morphology, solubility compressibility and particle size there may be a slight difference or change in the composition and proportions of ingredients. These slight differences may have an effect on the disintegration times for each family of Super Fast Disintegrating Powders. Each formulation will generally contain the same ingredients but may have slight changes in the overall aggregate. Nevertheless, the design of the fast disintegrating powder is such that it ensures immediate water absorption.

The Super Fast Disintegrating Powder technology has been designed to have quick dissolution and disintegration times. The powder's porosity has been maximized to ensure fast water absorption. The powder will be strategically designed for high bulk densities for achieving fast absorption and Superfast wetting of water into the powder's interior matrix. This strategy promotes the disassociation of particles to accommodate fast dissolution times. In addition to the high bulk densities the Super Fast Disintegrating Powder has been designed to yield low compaction to achieve good mechanical strength as well as excellent particle uniformity. The ingredients have been designed to promote high wettability.

The Super Fast Disintegrating Powders technology can be introduced in hot, cold, and warm solution. Super Fast Disintegrating Powders can be easily introduced into any wet or dry baking mix. Incorporating fast disintegrating technology into a powder is simply another way of providing a vehicle for which sugars, flavorings, colorings, vitamins, minerals, nutraceuticals, spices, botanicals, tea and coffee extracts will be integrated into an end product. All of the ingredients used in the Fast Disintegrating Powder technology are approved, are classified as foods and are generally recognized as safe for use in the food industry. It does not matter if the solution is cold and warm or hot, the fast disintegrating powder should dissolve in less than 15 seconds. As new ingredients are introduced into the Super Fast Disintegrating Powder matrix there is a possibility that there may be varying degrees of disintegration. Depending upon the agent's hygroscopicity, porosity, crystal morphology, solubility and particle size there may be a 15 second difference in disintegration activity. Nevertheless, the physical and chemical design of the Fast Disintegrating Powder is such that it accommodates maximum area contact for immediate water absorptivity.

We have chosen appropriate combinations of ingredients which provide fast disintegration and appropriate physical resistance. Most of the ingredients used in the Fast Disintegrating Powder technology are sugar-based. They have been chosen because of their high aqueous solubility and sweetness, pleasing mouth-feel, good taste masking. The ingredients used in the Super Fast Disintegrating Powder will be (GRAS) generally recognized as safe and the coloring as well as flavorings will be regulatory approved.

For the most part this patented technology will comprise of sugar based ingredients such as (dextrose, fructose, stevia, honey, isomalt, mannitol, sorbitol, etc,) starch ingredients such as (hydrolysate, polydextrose, xylitol, etc,) provides us with high aqueous solubility and sweetness. For the most part the disintegrant (Ac-Di-Sol, Polyplasdone®(XL), Amberlite® (IPR 88), Nymce, Primellose, Vivasol, Soy polysaccharide, Emcosoy, etc.), the pigment (Regulatory approved coloring agents),additional ingredients such as (tea and coffees, coffees, exotic fruit flavors, aromas, colorings, flavorings, extracts, nutraceuticals, etc,), sealants such as (hydrocolloid, etc.) may be leveraged in the direct compaction process to abet fast disintegration powder technology.

### BACKGROUND

Early Aztecs were one of the first to create a cocoa drink. They would pulverize beans into powder and dissolve the powder in hot water to provide a delicious nutritious drink. The Spanish capitalized on the Aztec's cocoa drink by shipping the concept to the new world. There is an ever growing quantity of powders that are being used to produce foods. The terminology powder is used in two different ways. It may be used to describe the physical form of material that may be composed of unique particles or it may be used to describe a type of preparation such as liquids as opposed to solids and gases. Some powders are used in the final processing of foods, while others are leveraged as ingredients for other complex food products. Finished process powders such as meal, flour, starches, corn meal, dried milk, etc. have become a dependable staple. A majority of powders being sold as food in the marketplace have been stripped of their nutritional value. They are simply used as bulking agents in processed foods. Most powdered snack being sold as food in the marketplace are starch-based. They yield high energy and low nutrition. These products cause a high incidence of obesity and gum disease. Soft drink manufacturers are notorious for using high fructose corn syrup, ascorbic acid, artificial flavor, citric acid, disodium EDTA, red 40, etc.

Powders are also used in the delivery of homeopathic or medicines, or medicinals. Health related powders were designed to act as a delivery system in the mouth of the patient. Powders are dissolved in the mouth with saliva to deliver remedies into the patient's bloodstream. Consumers are constantly striving to improve the nutritional profile of food products. Super Fast Disintegration Powder technology draws upon advances made for powders in the pharmaceutical and food technology. Super Fast Disintegrating Powder establishes new food delivery technologies using super fast disintegrants while at the same time including nutritional components such as vitamins, minerals, nutraceuticals, spices, etc. for teas coffees and functional food products.

The most common homeopathic remedies are liquids that are sugar based. The Super Fast Disintegration Powder is comprised of approved and generally recognized as safe sugars, flavorings, FD&C approved coloring agents, vitamins, minerals, nutraceuticals, spices, tea and coffee extracts or any combination thereof, and a super fast disintegrant that is used as a carrier to deliver the contents. The above ingredients have been heated, sprayed, spun and dried into a powder for the purpose of establishing a new mode of delivery for tea, coffee and food based products.

Tea is one of the most widely consumed beverages in the world, second only to water. Hundreds of millions of people drink tea around the world. Studies suggest that tea has many health benefits. The average cup of green tea contains approximately 40-140 mg polyphenols (antioxidants). Most tea dietary supplements are sold as dried leaf tea in the form of a capsule. Liquid extracts are made from the leaves and leaf buds. The healthful properties of tea are largely attributed to polyphenols and chemicals with potent antioxidant properties. Polyphenol content is so strong that the antioxidant effects of polyphenols appear to be greater than vitamin C. Polyphenols contained in teas are classified as catechins. Super fast disintegration technology captures six primary catechin compounds: epicatechin gallate, catechin, epicatechin, epigallocatechin, gallaogatechin, and apigallocatechin gallate and alkaloids including theophylline, theobromine, and caffeine into a powder by use of extracts. Super fast disintegration technology creates a new family of fast disintegrating tea powders.

Coffee is one of the most widely consumed beverages in the world, second only to water. From the opening of the first coffeehouse, our palate has been obsessed with this caffeinated drink. Flavor is perhaps the most important consideration in coffee quality. It is also one of the most variable components of coffee beans. Flavor is generally influenced by the species, the processing of the green coffee bean, the roasting method, and the method of brewing. Hundreds of millions of people drink coffee around the world, and studies suggest that the acids found in roasted coffee, chlorogenic, aliphatic and alicyclic carboxylic and phenolic acids in particular has many health benefits. Studies in many countries have shown that coffee is actually the major individual source of dietary antioxidants and laboratory studies have shown that some coffee constituents can create an atmosphere for the formation of carcinogen-detoxifying enzymes. The Super fast disintegration powder capitalizes on the bold flavor of coffee by merging coffee extracts onto a Super Fast Disintegrating powder. The Super Fast Disintegrating Powder provides delivery of tea, coffee and food based products in the form of powder.

A Super Fast Disintegrating Powder that's comprised of tea, coffee and various food extracts, sugars, flavorings, colorants, and a superfast disintigrant that has been heated, sprayed, spun and dried into a powder. The Super Fast Disintegrating Powder has a particle size of 200 micrometers to 2 mm. The powder is comprised of approved and generally recognized as safe sugars, flavorings, FD&C approved coloring agents, vitamins, minerals, nutraceuticals, spices, tea and coffee extracts or any combination thereof, and a super fast disintegrant that is used as a carrier to deliver the contents. The above ingredients have been heated, sprayed, spun and dried on to a Super Fast Disintegrant for the purpose of establishing a new mode of delivery for tea, coffee and food based products. The disintegrating powder should dissolve in less than 15 seconds in hot cold or ambient solution with little residue. The potency of the disintegrating powdered drink can be increased by adding more powder to solution or by increasing the potency of the ingredients contained within a unit amount of powder. The powder is an excellent delivery system because of it's:

Greater efficiency—the surface area of the Super Fast Disintegrating Powder has been designed to make it fully available to dissolve in solution.

Greater economy—The Super Fast Disintegrating Powder has low compression pressure and the powder's morphological mechanism has been designed to maximize the availability of short range intermolecular and interatomic attraction forces, such as Van der Waals forces. In addition, the powder porosity becomes one of the most critical parameters for the solution absorption process.

Porosity—The Super Fast Disintegrating Powder has high surface porosity that results in high real area of contact; the physical design of the Super Fast Disintegrating Powder is such that it ensures the immediate water absorption.

1. A Super Fast Disintegrating Powder that has a particle size of 200 micrometers to 2 mm, that's comprised of sugars, flavorings, FD&C approved coloring agents, vitamins, minerals, nutraceuticals, spices, tea and coffee extracts in any combination thereof, and a Super fast disintegrant for the purpose of establishing a new mode of delivery for tea, coffee and food based products.

2. The Super Fast Disintegrating Powder of claim 1, in which the powder has been designed to achieve immediate absorption and dissolution in 15 seconds in hot, cold or warm solution.

3. The Super Fast Disintegrating Powder of claim 1 in which the tea, coffee and food based product use a disintegrant as a carrier for the ingredients.

4. The Super Fast Disintegrating Powder of claim 1 in which the powder is comprised of a blend of generally recognized as safe ingredients per regulatory agencies.
